(19) United States
(12) Patent Application Publication
(10) Pub. No.: US 2024/0428083 A1
(43) Pub. Date: Dec. 26, 2024

(54) Differentially Private Split Vertical Learning

(71) Applicant: LiveRamp, Inc., San Francisco, CA (US)

(72) Inventors: Grzegorz Gawron, Krakow (PL); Philip Stubbings, Cardiff (GB); Chi Lang Ngo, London (GB)

(21) Appl. No.: 18/707,029

(22) PCT Filed: Nov. 2, 2022
(86) PCT No.: PCT/US2022/048661

§ 371 Date: May 2, 2024

Related U.S. Application Data
(60) Provisional application No. 63/275,011, filed on Nov. 3, 2021.

(51) Int. Cl. G06N 3/098; G06N 3/082

(52) U.S. Cl. CPC G06N 3/098; G06N 3/082

(57) ABSTRACT

A machine-learning system includes worker nodes communicating with a single server node. Worker nodes are independent neural networks initialized locally on separate data silos. The server node receives the last layer output (“smashed data”) from each worker node during training, aggregates the result, and feeds into its own server neural network. The server then calculates an error and instructs the worker nodes to update their model parameters using gradients to reduce the observed error. A parameterized level of noise is applied to the worker nodes between each training iteration for differential privacy. Each worker node separately parameterizes the amount of noise applied to its local neural network module in accordance with its independent privacy requirements.

### CROSS-REFERENCE TO RELATED APPLICATIONS

This application claims the benefit of U.S. provisional patent application No. 63/275,011, filed on Nov. 3, 2021. Such application is incorporated herein by reference in its entirety.

### BACKGROUND

Distributed collaborative machine learning enables machine learning across a distributed data environment of client nodes without the requirement of transferring unprotected data from the client nodes to a central node or server. This feature increases the privacy and security for the data being analyzed. In addition, the party analyzing the results of the data processing at the central node never has access to the raw data at the client nodes; instead, only the smashed data (the outputs of the final/cut layer of the local part of the model) are transferred to the central node during the training process, and the local part of the trained model is passed for inference.

One approach to distributed collaborative machine learning is federated learning. Using federated learning, the central node transfers a full machine learning model to each of the distributed client nodes containing their local data, then later aggregates the locally trained full machine learning models from each client node to form a global model at the central node. This allows for parallel model training, increasing the speed of operation of the system. A disadvantage of federated learning, however, is that each client node needs to run the full machine learning model. The client nodes in some real-world applications may not have sufficient computational capacity to process the full machine learning model, which may be particularly difficult if the machine learning models are deep-learning models. Another disadvantage is that transferring the full model might be communicationally expensive. There is also a privacy concern in giving each of the client nodes the full machine learning model.

An alternative to federated learning is split learning. Split learning splits the full machine learning model into multiple smaller portions and trains them separately. Assigning only a part of the network to train at the client nodes reduces processing load at each client node. Communication load is also improved, because only smashed data is transferred to the central node. This also improves privacy by preventing the client nodes from having access to the full machine learning model known to the central node or server.

Differential privacy is a method of protecting data privacy based on the principle that privacy is a property of a computation over a database or silo, as opposed to the syntactic qualities of the database itself. Fundamentally, a computation is considered differentially private if it produces approximately the same result when applied to two databases that differ only by the presence or absence of a single record in the data. Differential privacy is powerful because of the mathematical and quantifiable guarantees that it provides regarding the re-identifiability of the underlying data. Differential privacy differs from historical approaches because of its ability to quantify the mathematical risk of de-identification using an epsilon value, which measures the privacy “cost” of a query. Differential privacy makes it possible to keep track of the cumulative privacy risk to a dataset over many analyses and queries.

A vertically partitioned distributed data setting is one in which various databases or silos hold a number of different columns of data relating to the same individuals or entities. The owners of the data silos may wish to collaborate to use the distributed data to train a machine learning model or deep neural network to predict or classify some outcome under the constraint that the original data cannot be disclosed or exported from its original source. In addition, the collaborating silos may have varying degrees of risk tolerance with respect to the privacy constraints of the contributing data silos. It would be desirable therefore to develop a system for applying a machine learning model to a vertically partitioned distributed data network in order to maintain privacy using differential privacy techniques while also allowing for the various solutions afforded by machine learning processing.

Research papers on differential privacy and split learning include the following:
Dwork, Cynthia. “Differential privacy: A survey of results.” In International conference on theory and applications of models of computation, pp. 1-19. Springer, Berlin, Heidelberg, 2008.
Abadi, Martin, Andy Chu, lan Goodfellow, H. Brendan McMahan, Ilya Mironov, Kunal Talwar, and Li Zhang. “Deep learning with differential privacy.” In Proceedings of the 2016 ACM SIGSAC conference on computer and communications security, pp. 308-318. 2016.
Abuadbba, S., Kim, K., Kim, M., Thapa, C., Camtepe, S. A., Gao, Y., Kim, H., & Nepal, S. (2020). Can We Use Split Learning on 1D CNN Models for Privacy Preserving Training? Proceedings of the 15th ACM Asia Conference on Computer and Communications Security, ASIA CCS 2020, 305-318. https://doi.org/10.1145/3320269.3384740.
Thapa, C., Chamikara, M. A. P., & Camtepe, S. A. (2020). Advancements of federated learning towards privacy preservation: from federated learning to split learning. Studies in Computational Intelligence, 965, 79-109. https://arxiv.org/abs/2011.14818v1.
Thapa, C., Chamikara, M. A. P., Camtepe, S., & Sun, L. (2020). SplitFed: When Federated Learning Meets Split Learning. https://arxiv.org/abs/2004.12088v3.
Li, O., Sun, J., Yang, X., Gao, W., Zhang, H., Xie, J., Smith, V., & Wang, C. (2021). Label Leakage and Protection in Two-party Split Learning. http://arxiv.org/abs/2102.08504.
Vepakomma, Praneeth, Tristan Swedish, Ramesh Raskar, Otkrist Gupta, and Abhimanyu Dubey. “No peek: A survey of private distributed deep learning.” arXiv preprint arXiv: 1812.03288 (2018).

References mentioned in this background section are not admitted to be prior art with respect to the present invention.

### SUMMARY

In a machine according to the present invention, a machine-learning system or deep neural network is split into a number of “worker” modules and a single “server” module. Worker modules are independent neural networks initialized locally on each data silo. A server network receives the last layer output (referred to herein as “smashed data”) from each worker module during training, aggregates the result, and feeds into its own local neural network. The server then calculates an error, with respect to the prediction or classification task at hand, and instructs the sub-modules to update their model parameters using gradients to reduce the observed error. This process continues until the error has decreased to an acceptable level. A parameterized level of noise is applied to the worker gradients between each training iteration, resulting in a differentially private model. Each worker may parameterize the weighting of the amount of noise applied to its local neural network module in accordance with its independent privacy requirements. Thus the epsilon values (the measure of privacy loss for a differential change in data) at each worker are independent. The invention in certain embodiments thus represents the introduction of differential privacy in a vertically partitioned data environment in which different silos with independent privacy requirements hold different sets of features/columns for the same dataset.

One application of the invention in its various embodiments is to allow collaborating parties to train a single deep neural network with privacy guarantees. Due to the modular nature of the neural network topology, one may use trained “worker” neural network modules as privacy-preserving feature generators, which could be used as input to other machine learning methods. The invention thus allows for inter-organization and inter-line-of-business collaborative machine learning in regulated and constrained data environments where each silo holds varying sets of features.

These and other features, objects and advantages of the present invention will become better understood from a consideration of the following detailed description of the preferred embodiments and appended claims in conjunction with the drawings as described following:

### DRAWINGS

FIG. 1 is a swim lane diagram showing a process according to one embodiment of the present invention.

FIG. 2 is a structural diagram showing a system for implementing the process of FIG. 1.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

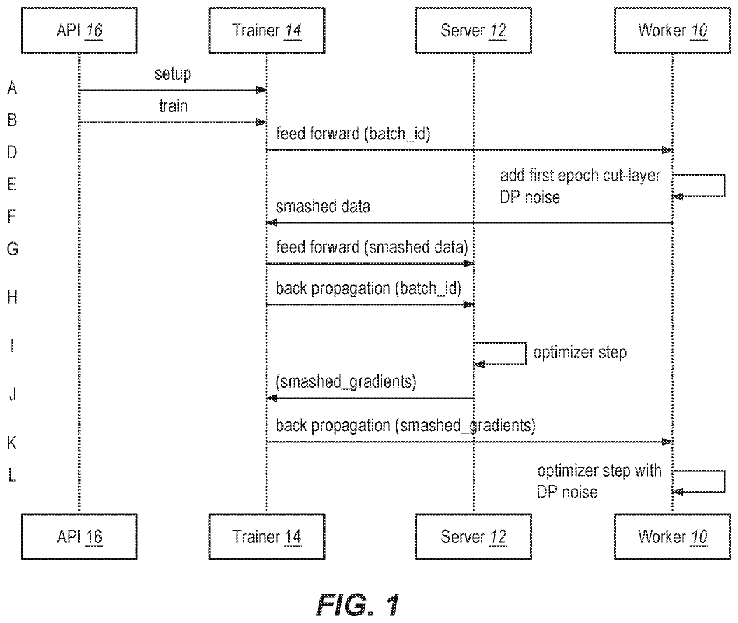

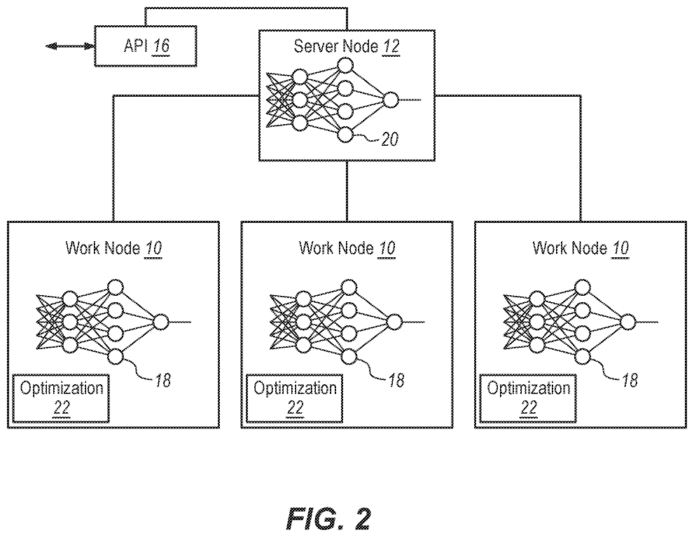

FIG. 1 illustrates a method according to one embodiment of the invention. This method is implemented using the structure of architecture diagram FIG. 2. The method may be used to train a deep neural network in a modular fashion. In this network, each module lives in a data silo, i.e., the data is vertically partitioned or “cut” into modules. Raw data is never allowed to leave its own silo, thereby protecting the privacy and security of the data because it is never shared with the server or coordinator. The output of each module (at the silo level) feeds into the input of a server node. The raw data is maintained sufficiently “far away” from the module output layer, which encodes an intermediate representation/transformation of the data.

As shown in FIG. 2, one component type is the worker nodes 10 holding independent local neural networks 18. FIG. 2 illustrates three worker nodes 10, but any number of two or more worker nodes 10 may be used in various implementations of the invention. A worker node 10 is installed on each data silo (or client) within the collaboration. A server node 12 holds an independent aggregation neural network 20 and a set of labels used during the training process, as shown in FIG. 2. The server node 12 is responsible for aggregating output from each worker module 10 and for coordinating the learning process between local neural networks 18. A third component type is an optimization module 22 on each worker node 10, which applies noise during each parameter update iteration during training. This noise introduces the differential privacy element into the network. A fourth component type is an application programming interface (API) 15, which allows a user to specify the columns of distributed data to be used in the training process and returns an aggregate/monolithic view of the trained network modules after training.

A problem with building a model with a neural network is whether one may be sure that the model has not memorized the underlying data, thereby compromising privacy. Known privacy attacks, such as membership interference attacks, may be performed by querying with specific input and observing output, allowing the attacker to discern privacy data even though there is no direct access to the data silo. In the network of FIG. 2, it may be seen that differential privacy (DP) is applied to each data silo or client node individually. Differential privacy is applied independently with respect to each client node, which allows for an independent choice of the client epsilon value. In addition, differential privacy is applied as well on the first forward pass to the cut layer (here referred to as the “smashed” epsilon value) as described following.

The process for applying machine learning using the system of FIG. 2 is shown in the swim lane diagram of FIG. 1. As noted above, this method allows for the split of epsilon (i.e., the noise level) across each of the worker nodes. In this way, the level of privacy may be specifically set for the data in each of these nodes. This allows for the treatment of individual privacy requirements particular to each data silo. Data that requires more privacy can be set with a lower epsilon value, while other data can be set with a higher epsilon value, thus improving the results of the system since there is no requirement to use the minimum epsilon value across all of the data silos.

As shown in the swim lane diagram of FIG. 1, the process begins at step A, at which the appropriate worker nodes 10 are set up at each data silo, the server is set up, and batch size for the neural networks is determined. Training at training node 14 begins at step B using a random batch of input data. The worker node 10 trains up its vertical split of the input batch through one or more layers of the local neural network 18 at step D. This continues at step E until a certain layer is reached, referred to herein as the cut layer. Step E is where optimization routine 22 adds the desired level of noise to the resulting smashed data. This only happens the first time a given batch is fed forward. Because the noise level is set independently at each of the worker nodes 10, the noise level may be configured with respect to the desired level of privacy for this worker node 10's particular vertical slice of the data set. Local processing at the worker node then ends. The worker node 12 then sends the smashed data with added noise up to trainer 14 at step F. The trainer 14, after having collected all of the noised, smashed data from all of the worker nodes 10, sends them to the trainer 14 at step G. Server 12 performs training (forward pass at step G and back propagation at step H) on its own local neural network 20 using the labels for the input batch being processed. The server node 12 sends back the output of its back propagation (smashed gradients) back to the trainer node 14 at step J. The trainer node 14 forwards the smashed gradients to all the worker nodes 10 at step K and each worker node runs its own local back propagation obtaining local gradients. At step L each of the worker nodes 10 applies differentially private noise to the local gradients and uses the obtained noised, smashed gradient to update the weights of its own local neural network. This process is repeated iterating over the batches of input data until the network training is complete based on the error reaching an acceptable level.

A potential problem in a system of this type is data leakage when applying noise only at the back-propagation phase as shown in FIG. 1. Attackers may attempt to infer the client model parameters and to recover the original input data, due to leakage to the server node 12 and back to the clients. The solution, as shown in FIG. 1, is to add an amount of noise to the cut-layer (referred to herein as “smashed” data) output during the first training epoch, using optimization modules 22.

Traditional split neural networks are vulnerable to model inversion attacks, as noted above. To reduce leakage, the distance correlation between model inputs and the cut layer activations (i.e., the raw data and the smashed data) may be minimized. This means that the raw data and the smashed data are maximally dissimilar. This approach has been shown to have little if any effect on model accuracy.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system's memory capabilities may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention.

1. A system for differentially private split vertical learning, comprising:
a server node comprising a server processor and a server neural network;
a first data silo in communication with the server node across a network, wherein the first data silo comprises a first subset of a dataset;
a second data silo in communication with the server across the network, wherein the second data silo comprises a second subset of the dataset;
a first worker node implemented at the first data silo, wherein the first worker node comprises a first local neural network and a first optimization routine, wherein the first worker node is configured to produce a first cut layer data set from the first data subset using the first local neural network, and the first optimization routine is configured to apply a first parameterized level of noise to the first cut level to produce a first smashed data set;
a second worker node implemented at the second data silo, wherein the second worker node comprises a second local neural network and a second optimization routine, wherein the second worker node is configured to produce a second cut layer from the second data subset using the second local neural network, and the second optimization routine is configured to apply a second parameterized level of noise to the second cut layer to produce a second smashed data set, wherein the second parameterized level of noise is set independently from the first parameterized level of noise;
wherein the server node is further configured to aggregate the first and second smashed data sets, train against the first and second smashed data sets for at least one additional layer in the server neural network to calculate an error against a prediction, and send a set of smashed gradients to the first and second worker nodes based on the error.

2. The system of claim 1, wherein the first parameterized level of noise has a different value from the second parameterized level of noise.

3. The system of claim 2, wherein the first subset of the dataset comprises a first vertical split of the dataset, and the second subset of the dataset comprises a second vertical split of the dataset.

4. The system of claim 3, wherein the first worker node prevents access to the first subset of the dataset by the server node, and further wherein the second worker node prevents access to the second subset of the dataset by the server node.

5. The system of claim 4, further comprising an application programming interface (API) in communication with the server node, wherein the API is configured to transmit a set of specified vertical columns to the server node and to return from the server node an aggregate view of the server neural network after training.

6. The system of claim 5, wherein the server node is further configured to back-propagate the error until the cut layer at the server neural network, wherein the first worker node is configured to further back-propagate past the cut layer at the first local neural network, and wherein the second worker node is configured to further back-propagate past the cut layer at the second local neural network.

7. The system of claim 6, wherein the server node is further configured to repeatedly aggregate the first and second smashed data sets and calculate the error against the prediction until the error has reached an accepted level.

8. A method for differentially private split vertical learning, the method comprising the steps of:
initializing a first worker node at a first data silo comprising a first data slice of a raw dataset, wherein the first worker node comprises a first local neural network receiving as input the first data slice, and initializing a second worker node at a second data silo comprising a second data slice of the raw dataset, wherein the second worker node comprises a second local neural network receiving as input the second data slice;
training the first local neural network against the first data slice up to a cut layer to produce a first local neural network output, and training the second local neural network against the second data slice up to the cut layer to produce a second local neural network output;
at a first optimization routine at the first worker node, applying a first noise level to the first local neural network output to produce a first smashed data set, and applying the first noise level to a first set of local gradients to produce a first set of weights;
at a second optimization routine at the second worker node, applying a second noise level to the second local neural network output to produce a second smashed data set, and applying the second noise level to a second set of local gradients to produce a second set of weights, wherein the second optimization routine operates independently from the first optimization routine; and
at a server node comprising an aggregate neural network, aggregating the first smashed data set and second smashed data set.

9. The method of claim 8, wherein the second noise level comprises a different value from the first noise level.

10. The method of claim 9, further comprising the step of training against the aggregated first smashed data set and the second smashed data set at the aggregate neural network to calculate an error against a prediction.

11. The method of claim 10, further comprising the step of sending from the server node to the first worker node and the second worker node a set of updated parameters based on the error.

12. The method of claim 11, wherein the first data slice is a first vertical slice of the dataset, and the second data slice is a second vertical slice of the data set that does not overlap with the first vertical slice of the dataset.

13. The method of claim 12, further comprising the step of blocking access by the server node to the first data slice at the first worker node, and blocking access by the server node to the second data slice at the second worker node.

14. The method of claim 13, further comprising the step of back-propagating the error at the aggregate neural network until the cut layer is reached.

15. The method of claim 14, further comprising the steps of back-propagating the error at the first local neural network beginning from the cut layer, and back-propagating the error at the second local neural network beginning from the cut layer.

16. The method of claim 15, further comprising the step of, after back-propagating from the error at the first local neural network, feeding forward at the first local neural network up to the cut layer, and further comprising the step of, after back-propagating from the error at the second local neural network, feeding forward at the second local neural network up to the cut layer.

17. The method of claim 16, further comprising the step of producing a subsequent first smashed data set and a subsequent second smashed data set.

18. The method of claim 17, further comprising the step of calculating a second error at the server node after receiving the subsequent first smashed data set and subsequent second smashed data set.

19. The method of claim 18, further comprising the step of outputting a monolithic view of the aggregated neural network from an application programming interface (API).

20. The method of claim 8, comprising the step of setting the first noise level based on a first privacy epsilon value for the first data slice, and setting the second noise level based on a second privacy epsilon value for the second data slice.
